(19) United States
(12) Patent Application Publication
(10) Pub. No.: US 2021/0146546 A1
(43) Pub. Date: May 20, 2021

(54) METHOD TO CONTROL A ROBOT IN THE PRESENCE OF HUMAN OPERATORS

(71) Applicant: Ford Global Technologies, LLC, Dearborn, MI (US)

(72) Inventors: Gregory P. Linkowski, Dearborn, MI (US); Shankar Narayan Mohan, Ann Arbor, MI (US)

(73) Assignee: Ford Global Technologies, LLC, Dearborn, MI (US)

(21) Appl. No.: 16/688,490

(22) Filed: Nov. 19, 2019

(51) Int. Cl. B25J 9/16; G06K 9/00

(52) U.S. Cl. CPC B25J 9/1676; G06K 9/00362; B25J 9/1694; B25J 9/1666

(57) ABSTRACT

A method for a human-robot collaborative operation includes having a robot perform at least one automated task within a workspace and generating a dynamic model of a workspace based on a static nominal model of the workspace and data from a plurality of sensors disposed throughout the workspace. The method further includes controlling operation of the robot based on the dynamic model and the human operation, and verifying completion of the human operation based on a task completion parameter associated with the human operation and on based on at least one of the dynamic model, the data from the plurality of sensors, and the at least one automated task performed by the robot.

### FIELD

The present disclosure relates to controlling robots in a manufacturing environment having human operators based on tasks performed by the robot and the human operators.

### BACKGROUND

The statements in this section merely provide background information related to the present disclosure and may not constitute prior art.

Industrial robots excel at tasks that are repeatable and physically intense (often beyond the capability of a human being). Capable of moving at several meters per second; the faster a robot moves, the greater benefit to production. In some instances, humans and robots work together as part of a human-robot collaborative operation in which a robot performs an automated task and the human performs a human operation on a workpiece. To inhibit collision between the robot and human, the force and speed of the robot is typically limited.

Technological developments in human-robot collaborative operations has precipitated interactive production facilities that include robots for enabling reconfigurable and more efficient layouts. But human-robot collaborative operations by their very nature require precise monitoring of not only the robot, but also the human to provide uninterrupted workflow.

These issues with the use of industrial robots alongside human operators in a production environment, among other issues with industrial robots, are addressed by the present disclosure.

### SUMMARY

This section provides a general summary of the disclosure and is not a comprehensive disclosure of its full scope or all of its features.

The present disclosure provides a system for a human-robot collaborative operation. The system comprises: a plurality of sensors disposed throughout a workspace, wherein the plurality of sensors includes at least one sensor that acquires data related to a human operation to be performed by a human on a workpiece; a robot operable to perform at least one automated task within the workspace; and a workspace control system. The workspace control system includes a memory storing an object classification library that associates a plurality of predefined objects with one or more classifications and a workspace controller. The workspace controller is configured to operate as a dynamic workspace module configured to generate a dynamic model of the workspace based on a static nominal model of the workspace and data from the plurality of sensors, wherein the dynamic workspace module is configured to classify one or more objects provided within the workspace based on the dynamic model and the object classification library. The workspace controller is further configured to operate as a task management module configured to verify completion of the human operation based on a task completion parameter associated with the human operation, wherein the task management module is configured to determine whether the task completion parameter is satisfied based on at least one of the dynamic model, the data from the plurality of sensors, and the at least one automated task performed by the robot.

In one form, the task completion parameter is based on at least one of: a workpiece connectivity characteristic, wherein the human operation includes connecting at least two components, and the task management module is configured to verify that the human operation is complete based on an electrical connection, a mechanical connection, or a combination thereof between the at least two components; a workspace audio-visual characteristic, wherein the task management module is configured to verify that the human operation is complete based on a visual inspection, an acoustic evaluation, or a combination thereof of the workspace; a tool operation verification of a power tool used by the human for performing the human operation, wherein the human operation includes a machine operation to be executed with the power tool, and the task management module is configured to determine whether the machine operation of the power tool satisfies a predefined tool criteria for the human operation; and a robot tactile verification, wherein, as one of the at least one automated task, the robot is configured to perform a tactile evaluation of the workpiece using a tactile sensor, and the task management module is configured to compare data from the tactile sensor to a post workpiece tactile threshold to verify whether the human operation is complete.

According to this form, the plurality of sensors includes a camera operable to capture one or more images of the workspace, an acoustic sensor operable to detect acoustic waves within the workspace, or a combination thereof. And, for the workspace audio-visual characteristic, the task management module is configured to compare a current state of the workspace having the workpiece with a work state to verify whether the human operation is complete, wherein the predefined post operation state provides a state of the workspace after the human operation is performed, and/or analyze a workspace audio signal indicative of the detected acoustic waves with a nominal audio signal profile indicative of an audio signal generated during the human operation.

The predefined post operation state of the workspace may include a physical appearance of the workpiece after the human operation is performed, removal of an assembly component from a designated area, and/or transfer of an assembly component provided within the workspace.

In another form, the at least one image sensor is an infrared camera operable to acquire a thermal image of the workspace, and for the tool operation verification, the predefined tool criteria is based on a nominal thermal profile of a selected portion of the workspace at which the power tool is being operated during the human operation.

In yet another form, the task management module is communicably coupled to the power tool to acquire data indicative of the machine operation performed by the power tool, wherein the data indicative of the machine operation includes at least one of a torque of the power tool, an electric power provided to the power tool, a contact state of a chuck of the power tool, and a contact state of a handle of the power tool.

In still another form, the workspace controller is further configured to operate as an adaptive robot control module configured to operate the robot based on a comparison of the dynamic model and the static nominal model of the workspace, wherein the adaptive robot control module is configured to determine a probable trajectory of a dynamic object provided in the dynamic model based on a prediction model, wherein the prediction model determines probable trajectories of a dynamic object within the workspace and adjust at least one robot parameter based on the probable trajectory of the dynamic object and a future position of the robot.

In this form, the adaptive robot control module is configured to control subsequent movement of the robot after the task management module verifies completion of the human operation.

In another form, the object classification library associates the plurality of predefined objects with one of the following classifications: a robot, a human, a moveable object, or a fixed object.

In yet another form, the robot is uncaged.

In another form, the system further comprises a plurality of the robots, wherein a first robot is operable to move the workpiece as a first automated task and a second robot is operable to inspect the workpiece as a second automated task, and the task management module is configured to determine whether the human operation is complete based on the second automated task.

The present disclosure further provides a method comprising having a robot perform at least one automated task within a workspace, generating a dynamic model of a workspace based on a static nominal model of the workspace and data from a plurality of sensors disposed throughout the workspace, wherein the plurality of sensors includes at least one sensor that acquires data related to a human operation to be performed by a human on a workpiece, controlling operation of the robot based on the dynamic model and the human operation, and verifying completion of the human operation based on a task completion parameter associated with the human operation and based on the dynamic model, the data from the plurality of sensors, the at least one automated task performed by the robot, or a combination thereof.

In one form, the task completion parameter is based on at least one of a workpiece connectivity characteristic, a workspace audio-visual characteristic, a tool operation verification of a power tool used by the human for performing the human operation, and a robot tactile verification. In this form, the method further comprises: for the workpiece connectivity characteristic of the workpiece, determining whether at least two components to be connected during the human operation form an electrical connection, a mechanical connection, or a combination thereof between the at least two components; for the visual characteristic of the workspace, comparing a current state of the workspace having the workpiece with a predefined post operation state to verify whether the human operation is complete, wherein the predefined post operation state provides a state of the workspace after the human operation is performed; for the workspace audio-visual characteristic, verifying that the human operation is complete based on a visual inspection, an acoustic evaluation, or a combination thereof of the workspace; for the tool operation verification of a power tool used by the human for performing the human operation, determining whether a machine operation of the power tool that is included as part of the human operation satisfies a predefined tool criteria; and/or for the robot tactile verification in which one of the at least one automated task of the robot includes a tactile evaluation of the workpiece using a tactile sensor, comparing data from the tactile sensor to a post workpiece tactile threshold to verify whether the human operation is complete.

Furthermore, for the workspace audio-visual characteristic, the method may further include (1) comparing a current state of the workspace having the workpiece with a work state to verify whether the human operation is complete, wherein the predefined post operation state provides a state of the workspace after the human operation is performed, and/or (2) measuring audible signal within the workspace during the human operation, and comparing a workspace audio signal profile indicative of the measured audible signal with a nominal audio signal profile indicative of an audio signal generated during the human operation under nominal operating conditions.

The predefined post operation state of the workspace may include a physical appearance of the workpiece after the human operation is performed.

In another form, the at least one image sensor is an infrared camera operable to acquire a thermal image of the workspace, and for the tool operation verification, the predefined tool criteria is based on a thermal profile of a selected portion of the workspace at which the power tool is being operated during the human operation.

In yet another form, the method further comprises acquiring data indicative of the machine operation performed by the power tool, wherein the data indicative of the machine operation includes at least one of a torque of the power tool, an electric power provided to the power tool, a contact state of a chuck of the power tool, and a contact state of a handle of the power tool.

In another form, the method further comprises determining a probable trajectory of a dynamic object provided in the dynamic model based on a prediction model, wherein the prediction model determines probable trajectories of the dynamic object within the workspace; adjusting at least one robot parameter based on the probable trajectory of the dynamic object and a future position of the robot; and operating the robot to perform a subsequent task after the human operation is verified as being completed.

The present disclosure further provides a method comprising: having a robot perform at least one automated task within a workspace; generating a dynamic model of a workspace based on a static nominal model of the workspace and data from a plurality of sensors disposed throughout the workspace, wherein the plurality of sensors includes at least one sensor that acquires data related to a human operation to be performed by a human on a workpiece; identifying the human within the dynamic model; determining a probable trajectory of the human provided in the dynamic model based on a prediction model, wherein the prediction model determines probable trajectories of a dynamic object within the workspace; controlling operation of the robot based on the probable trajectory of the human and a future position of the robot; and verifying completion of the human operation based on a task completion parameter associated with the human operation and on based on at least one of the dynamic model, the data from the plurality of sensors, and the at least one automated task performed by the robot.

According to this form, the task completion parameter is based on at least one of a connectivity characteristic of the workpiece, a visual characteristic of the workspace, a tool operation verification of a power tool used by the human for performing the human operation, and a robot tactile verification, wherein the method further comprises: for the connectivity characteristic of the workpiece, determining whether at least two components to be connected during the human operation form an electrical connection, a mechanical connection, or a combination thereof between the at least two components; for the visual characteristic of the workspace, comparing a current state of the workspace having the workpiece with a predefined post operation state to verify whether the human operation is complete, wherein the predefined post operation state provides a state of the workspace after the human operation is performed; for the tool operation verification of a power tool used by the human for performing the human operation, determining whether a machine operation of the power tool that is included as part of the human operation satisfies a predefined tool criteria; and/or for the robot tactile verification in which one of the at least one automated task of the robot includes a tactile evaluation of the workpiece using a tactile sensor, comparing data from the tactile sensor to a post workpiece tactile threshold to verify whether the human operation is complete.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a workspace having a robot and a human operator;

FIG. 2 is a block diagram of a system having a workspace control system in accordance with present disclosure;

FIG. 3 is a block diagram of the workspace control system having a workspace controller in accordance with present disclosure;

FIG. 4 is a block diagram of a dynamic workspace module of the workspace controller in accordance with present disclosure;

FIG. 5 is a block diagram of an adaptive robot control module of the workspace controller in accordance with present disclosure;

FIG. 6 is a block diagram of a task management module of the workspace controller in accordance with present disclosure;

FIG. 7 illustrates one form of a visual inspection of a workspace for verifying completion of a human operation in accordance with present disclosure;

FIG. 8 illustrates another form of a visual inspection of a workspace for verifying completion of a human operation in accordance with present disclosure;

FIG. 9 is a flowchart of a dynamic workspace modeling routine in accordance with the present disclosure;

FIG. 10 is a flowchart of a robot operation routine in accordance with the present disclosure;

FIG. 11 is a flowchart of an adaptive robot control routine in accordance with the present disclosure; and

FIG. 12 is a flowchart of a task completion routine in accordance with the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

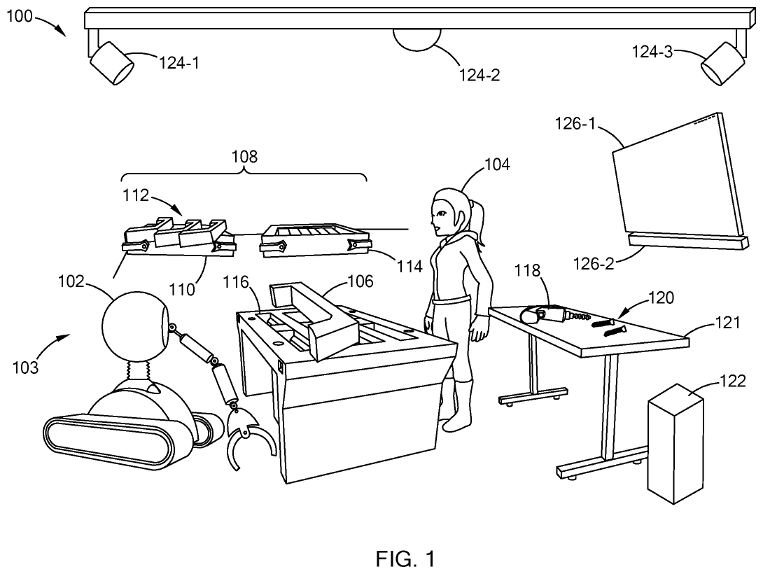

Referring to FIG. 1, a workspace 100 provided in a manufacturing facility is a collaborative environment in which a robot 102 and a human operator 104 work and interact with one another to process a workpiece 106. Here, the workspace 100 is an uncaged area having no fence or other containment-like structure for confining the movement of the robot 102. The robot 102 is configured to perform one or more automated tasks with the human operator 104 who is performing one or more human operations.

As an example, the robot 102 transports the workpiece 106 to and from a staging area 108 that has a first pallet 110 for unprocessed workpieces 112 and a second pallet 114 for processed workpieces. The automated tasks may include the robot 102 moving to the staging area 108, picking up an unprocessed workpiece 112 from the first pallet 110, moving the unprocessed workpiece 112 to a workbench 116, placing the unprocessed workpiece 112 on the workbench 116, and moving the processed workpiece to the second pallet 114 once the human operator 104 has completed his/her tasks, or in other words, human operations(s). The staging area 108 may be within the workspace 100, as illustrated in FIG. 1, but may also be outside the workspace 100 within the manufacturing facility. Once placed on the workbench 116, the unprocessed workpiece 112 may be referred to as the workpiece 106. The human operator 104 performs at least one human operation on the workpiece 106 such as, but not limited to, inspecting the workpiece 106 for possible defects, and operating a power tool 118 to install one or more fasteners 120. The power tool 118 and the fasteners 120 are provided on a table 121. In one variation, the robot 102 may change the position of the workpiece 106 to allow the human operator 104 perform additional operations on different areas of the workpiece 106.

For a human-robot collaborative operation such as the one described with respect to FIG. 1, the present disclosure provides a workspace control system 122 that operates the robot 102 of a robotic system 103 in a continuous manner such that after the human operator 104 completes the human operation, the robot 102 performs its next task. More particularly, the workspace control system 122 determines whether the human operator 104 completes a human operation and then controls the robot 102 to perform the next automated task. The workspace control system 122 is further configured to adaptively control the robot 102 based on a projected trajectory of a human traveling in the vicinity of the robot 102 such that the robot 102 is able to work safely and collaboratively alongside humans.

While a specific human-robot collaborative operation is described and illustrated in FIG. 1, the teachings of the present disclosure are applicable to other human-robot collaborative operations and should not be limited to the example provided herein. For example, a human-robot collaborative operation may be a dexterity task in which a human operator places bolts onto a workpiece and the robot drives the bolts into place. In this example, the workspace control system of the present disclosure verifies that the bolts are in place before having the robot perform its task. In another example of a human-robot collaborative operation, the robot inspects the operation performed by the human to catch errors.

The automated tasks and/or human operations performed in a given workspace may be carried out by more than one robot and/or more than one human operator. As an example, one robot may be used to manipulate a workpiece while another robot may be used to inspect the workpiece, and two human operators may perform the same or different human operation on the same or different workpiece.

To monitor the robot 102 and/or the human operator 104 and exchange information with the human operator 104, the workspace 100 includes multiple sensors 124-1, 124-2, 124-3 (collectively “sensors 124”), one or more human interface devices such as a touchscreen display 126-1 to display information and acquire inputs from the human operator 104, and an audio system 126-2 having a speaker and a microphone. The touchscreen display 126-1 and the audio system 126-2 may generally be referred to as human machine interfaces (HMI) 126 for exchanging information with a human.

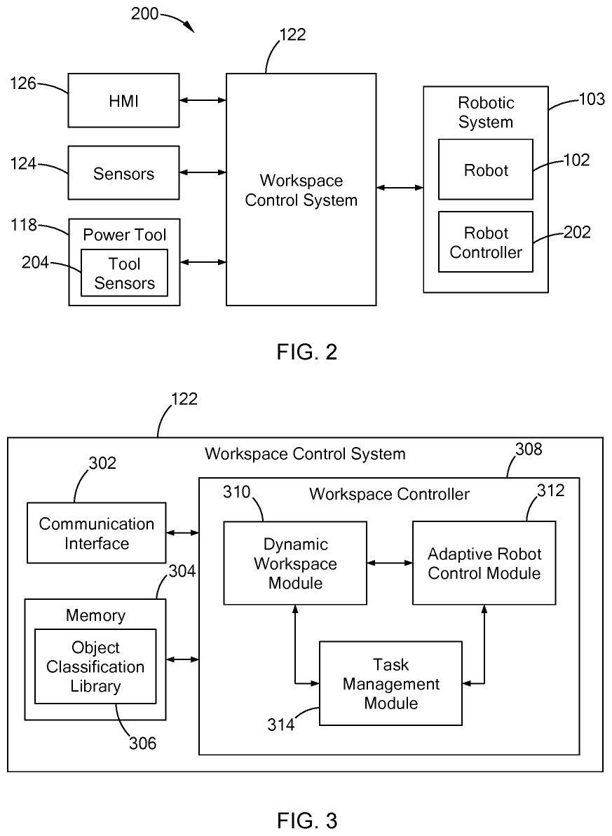

The various components of the workspace form a system for managing a human-robot collaborative operation. More particularly, FIG. 2 illustrates a block diagram of a system 200 that includes the workspace control system 122, the robotic system 103, the sensors 124, the HMI 126, and the power tool 118. The workspace control system 122 is communicably coupled to the other components of the system 200 by way of wireless and/or wired communication link(s). In one form, the workspace control system 122 is communicably coupled by way of an area network, a dedicated communication link, or a combination thereof. Accordingly, the system 200 and the components within the system 200 include hardware such as transceivers, routers, input/output ports, and software executable by microprocessor to establish the communication link in accordance with a standard protocol such as Bluetooth, Zigbee, WI-FI, and cellular protocols, among others.

The sensors 124 may include, but are not limited to: two-dimensional cameras, three-dimensional cameras, infrared cameras, LIDARs (light detection and ranging), laser scanners, radars, accelerometers, electromagnetic wave sensors such as microphones and monocular cameras. As described herein, the workplace control system 122 uses the data from the sensors 124 to form a dynamic model of the workspace 100. The dynamic model is further utilized to identify a moving object (i.e., a dynamic object) within the workspace 100, track the position of the moving object, and to verify completion of a human operation. In one form, the sensors 124 may also include sensors provided at other components such as the power tool 118 and robot (includes robot 102 and/or other robots).

The HMIs 126 provide information to the human operator and may be operable to by the human operator to provide information to the workspace control system 122. For example, the touchscreen display 126-1 displays information such as, but not limited to the dynamic model, the human operation to be performed, identification information related to the workspace 100, and the workpiece 106 being worked on. The touchscreen display 126-1 may also display queries that are to be answered by the human operator by a touch of the display or vocally, which is detected by the microphone of the audio system 126-2. While specific HMI 126 are depicted, other HMI may also be used such as buttons, dedicated computing devices (e.g., laptops, tablets), barcode scanners, among others.

The power tool 118 is operable by the human operator 104 to, for example, to drive fasteners or drill holes, among other operations. The power tool 118 generally includes a supplementary power source such as an electric motor and compressed air, to provide supplemental power other than manual force exerted by the human operator to perform an operation. In one form, the power tool 118 includes sensors disposed therein, which are referred to as tool sensor(s) 204, for measuring performance of the power tool 118. For example, the tool sensors 204 may include, but are not limited to a torque sensor, a power sensor to measure current and/or voltage being applied by the supplementary power source, an accelerometer to measure a vibration profile during operation, a touch sensor at the handle to detect contact, and/or a contact sensor at a chuck of the power tool to detect the presence of a bit/fastener within the chuck. While the power tool 118 is provided as a drill motor, other power tools may be used such as an impact wrench, a nail gun, and/or a grinder, among others, to perform other operations such as cut, shape, sand, grind, route, polish, paint, and/or heat. In addition, the power tool 118 is an optional component and may not be part of the workspace 100 and thus, the system 200. In another variation, the workspace 100 may include more than one power tool.

The robotic system 103 includes the robot 102 and a robotic controller 202 configured to operate the robot 102 based on instructions from the workspace control systems 122. The robotic controller 202 is configured to store computer readable software programs that are executed by one or more microprocessors within the controller 202 to operate the robot 102. For example, the robot 102 includes one or more electric motors (not shown) that are driven by the robotic controller 202 to control movement of the robot 102. While the workspace 100 is illustrated as having one robotic system 103, the workspace 100 may include more than one robotic system for performing same and/or different automated operations. For example, one robotic system may be operable to manipulate a workpiece 106 and another robotic system may be used to verify the human operation is complete. In another variation, the same robotic system may be used to manipulate the workpiece and to verify the human operation.

The workspace control system 122 is configured to command or control the operation of the robot 102 and verify the completion of the human operation. Referring to FIG. 3, in one form, the workspace control system 122 includes a communication interface 302, a memory 304 for storing an object classification library 306, and a workspace controller 308. The workspace control system 122 may be realized using one or more controllers having memory circuits distributed at the same or different locations through the production facility. For example, the workspace controller 308 may be realized using two or more physically separated controllers that are communicably coupled and can be an edge computing device located within the production facility not necessarily within the workspace 100, and/or a local computing device disposed at the workspace 100. The one or more controllers may include a microprocessor(s), a memory for storing code executed by the microprocessor(s), and other suitable hardware components to provide the described functionality of the workspace control system 122.

The communication interface 302 is configured to communicably couple the workspace controller 308 with one or more external devices such as, but not limited to the robotic system 103, the power tool 118, the sensors 124, and/or the HMI 126. The communication interface 302 is configured to support wired communication links and wireless communication links to a local network and/or to individual external devices. Accordingly, the communication interface 302 may include input/output ports, transceivers, routers, and a microprocessor configured to execute software programs indicative of establishing communication links via one or more communication protocols.

The workspace controller 308 is configured to include a dynamic workspace module 310, an adaptive robot control module 312, and a task management module 314. The dynamic workspace modules 310 is configured to generate a dynamic model of the workspace 100 and classify objects provided in the dynamic model based on a static nominal model of the workspace 100 and data from the sensors 124. The adaptive robot control module 312 is configured to adaptively control/operate the robot 102 to have the robot 102 perform the automated tasks in collaboration with the human operator. The task management module 314 is configured to verify whether the human operator has completed the human operation based on data from the sensors 124, the robot 102, and/or other methods independent of a verification provided by the human operator. That is, the task management module 314 is configured to perform a verification that is based on data and not solely on an inquiry transmitted to the human operator.

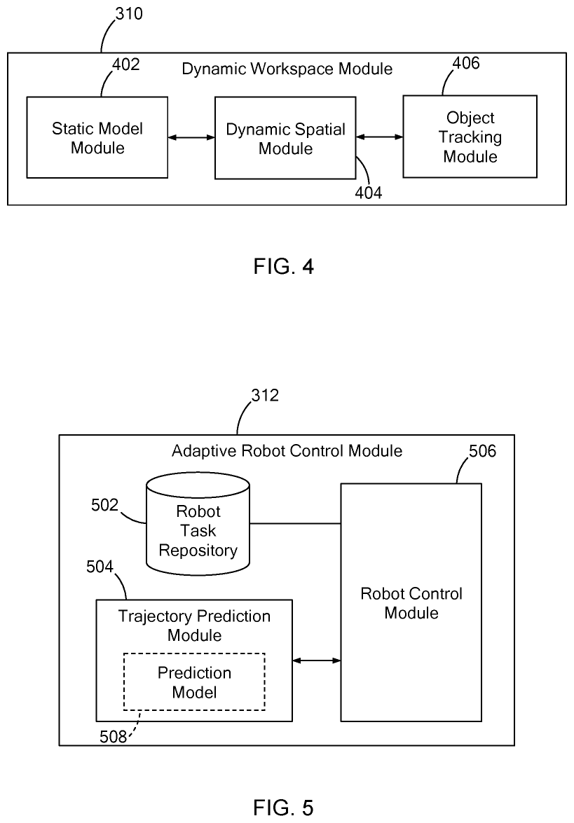

Referring to FIG. 4, in one form, the dynamic generation module 310 includes a static model module 402, a dynamic spatial module 404, and an object tracking module 406. The static model module 402 is configured provide a virtual representation of the workspace 100 in its as-designed state, which is referred to a static nominal model. For example, the static nominal model may define boundaries of the workspace 100 and include fixed objects such as the workbench 116. In one form, the static nominal model may be predetermined and stored by the static model module 402. If new features are added to the workspace 100, the static nominal model may be updated and stored. In another form, the static model module 402 is configured to record the data from the sensors 124 during a set-up or training time when the workspace is set to an initial state. In yet another form, the static model could be created by a computer aided design (CAD) drawing/modeling of the space and objects within it and/or a model where modeled components can be moved, such as having a modeled component indicative of the robot being configured according to joint angles measured by the built-in encoders.

The dynamic spatial module 404 is configured to generate the dynamic model based on data from the sensors 124 and the static nominal model. For example, with at least one of the sensors 124 being one or more 2D/3D cameras, the dynamic spatial module 404 performs a spatial transformation of the data from the 3D camera. Using the static nominal model, dynamic spatial module 404 performs a mapping function that defines a spatial correspondence between all points in an image from the camera(s) with the static nominal model. Known spatial transformation techniques for digital image processing may be implemented. For example, a checkerboard, QR-Code style artifact, can be used to calibrate extrinsic characteristics, which is the location and rotation of the sensors 124. With the extrinsic characteristics, known algorithms are used to position the recorded data in the real world (i.e., to convert from the camera frame to the world frame).

The object tracking module 406 is configured to identify and classify objects provided in the dynamic model based on the object classification library 306 and track movement of classified objects that are moving. The object classification library 306 associates a plurality of predefined objects with one or more classifications. The object classification library 306 may be provided as a database provided remotely from the workspace controller 308. The classification may include, but is not limited to: robot, human, moveable object (e.g., workpiece, power tool, fasteners), or static object (e.g., workbench, table, HMI, etc.).

In one form, the object tracking module 406 is configured to execute known image segmentation and object recognition processes that identify objects (moving and/or static) in the dynamic model and classify the object based on the object classification library 306. In another example, the dynamic spatial module 404 is configured to execute known point cloud clustering processes such as iterative closest point matching and its variants to identify objects within a 3D point cloud of the dynamic model and classify the objects using the object classification library 306. For example, the object tracking module 406 clusters points based on position and velocity such that points in close proximity and with similar trajectory are grouped as a single cluster and identified as an object. The clusters are then classified using the data in the object classification library. In another example, objects could be classified using 2D cameras and using the transformation from the extrinsic calibration, the matching point cluster can be determined.

In one form, the object tracking module 406 is further configured to remove selected objects from the dynamic model. For example, in FIG. 1, the selected objects may include the workbench 116, HMI 126, pallets 110, 114, and/or the table 121. This reduces the complexity of the model since the selected objects are generally static objects that are immaterial to the human operation and/or the automated operation.

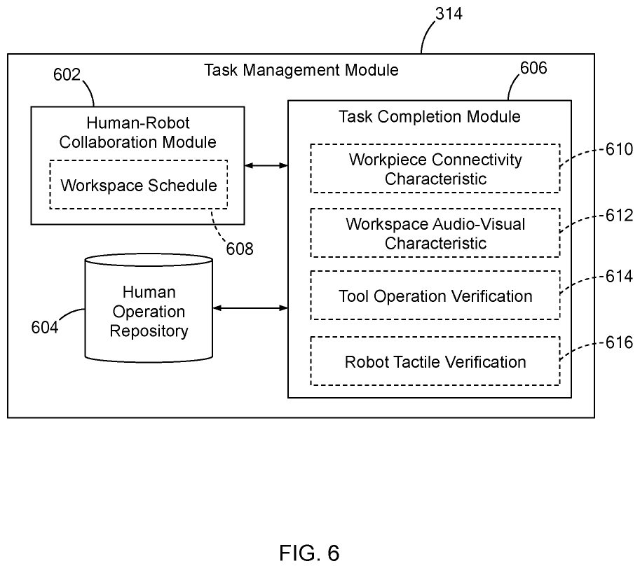

The adaptive robot control module 312 is configured to operate the robot 102 by transmitting commands to the robotic system 103 and specifically, the robotic controller 202. Referring to FIG. 5, in one form, the adaptive robot control module 312 includes a robot task repository 502, a trajectory prediction module 504, and a robot control module 506. The robot task repository 502 stores predefined automated tasks to be performed by the robotic system 103. The predefined automated tasks are associated with one or more commands to be provided to the robot controller 202 for having the robot 102 execute the automated task. The commands may include operation parameters for the robot 102 such as operation state (e.g., wait, stop, off, moving, etc.), speed, trajectory, acceleration, torque, rotation directions, among others. While the robot task repository 502 is provided as being part of the workspace controller 305, the robot task repository 502 may be stored with the object classification library 306 or at another location.

The trajectory prediction module 504 is configured to determine a projected trajectory of a classified moving object such as a human, using a prediction model 508. The prediction model 508 can be configured in various suitable ways using known models. As an example, in one form, a prediction model selects a time horizon that considers sensor latency and path planning delays such that a planned maneuver of the robot will not become unsafe before it is implemented. Then, a forward reachable set (FRS) is precomputed offline using a detailed model, giving the effects of a human trajectory for given input parameters in that time period. Obstacles are then projected into the FRS to identify parameter values that are deemed safe; those that avoid or inhibit a collision. Next, a user-defined cost function selects the best input parameters to use for the current time horizon. While a specific example is provided, it should be readily understood that other prediction models may be used.

Using the projected trajectory of the classified moving object, the robot control module 506 is configured to determine whether the operation parameter for a command to be executed by the robotic system 103 should be adjusted. More particularly, the robot control module 506 knows the current and future position of the robot 102 and the operating state of the robot 102 based on the automated tasks to be performed. Using the dynamic model and the projected trajectory of the classified moving object, the robot control module 506 calculates a current distance and forecasted distance between the robot 102 and the classified moving object. If the distance is less than a first distance setpoint and the robot 202 is moving at that time, the robot control module 506 has the robot controller 202 reduce, for example, the speed of the robot 102 to inhibit collision with the classified moving object. If the distance is less than a second distance setpoint that is less than the first distance setpoint (i.e., the robot and the classified moving object are closer), the robot control module 506 has the robot controller 202 place the robot 102 in a wait state in which the robot 102 stops the task (i.e., movement) until the classified moving object is a safe distance. Thus, inhibiting collision with the classified moving object.

In one variation, the robot control module 506 is configured to calculate a time-to-contact (T2C) between the robot 102 and the classified moving object, and compares the calculated time to one or more predetermined setpoints (e.g., 10 secs, 5 secs, etc.). For example, if the T2C is greater than a first setpoint (SP1), the robot control module 506 performs a normal operation. If T2C is less than SP1 but greater than a second setpoint (SP2), the robot control module 506 adjusts the operation parameters of the robot 102 if the robot is performing a task. If the T2C is less than tSP2, the robot control module 506 places the robot in a wait state until the classified moving object is a safe distance or T2C from the robot 102. Accordingly, the robot control module 506 adaptively controls the robot 102 based on the movement of the classified moving object provided in the dynamic model. In the event a non-classified moving object is moving towards the robot 102 and is a certain distance away from the robot 102, the robot control module 506 is configured to place the robot in the wait state.

The robot control module 506 is also configured to control subsequent movement of the robot 102 after the task management module 314 verifies completion of the human operation. Specifically, based on the automated tasks and the human operations to be collaboratively performed, the robot control module 506 operates the robot 102 to perform an automated task to be performed after the human operation is completed and the human operator is a set distance away from the robot.

The task management module 314 is configured to verify completion of the human operation based on a task completion parameter associated with the human operation. Referring to FIG. 6, in one form, the task management module 314 includes a human-robot collaboration module 602, a human operation repository 604, and a task completion module 606. The human-robot collaboration module 602 is configured to monitor the human-robot collaboration operation to be performed in the workspace 100. Specifically, in one form, the human-robot collaboration module 602 includes a workspace schedule 608 outlining the automated tasks and the human operations to be performed in the workspace, and the order in which the tasks/operations are to be performed.

The human operation repository 604 is configured to define one or more human operations to be performed and one or more task completion parameters used by the task completion module 606 to verify that a given human operation is complete. For example, for each human operation, the human operation repository 602 defines criteria for the human operation such as, but not limited to: number of fasteners to be installed; workpiece(s) under fabrication during the human operation; connectivity characteristics of the workpiece(s) being joined (electrical connectivity, mechanical, or both); positional movement of the power tool 118; machine operation(s) of the power tool (e.g., a torque of the power tool 118, an electric power provided to the power tool 118, a contact state of a chuck of the power tool 118, and/or a contact state of a handle of the power too 1181); predefined post operation state of the workspace 100 with or without workpiece; a post workpiece tactile threshold to be sensed by a robot; and/or a nominal audio signal profile indicative of an audio signal generated during the human operation. While the human operation repository 604 is provided as being part of the workspace controller 305, the human operation repository 604 may be stored with the object classification library 306 or at another location.

The task completion module 606 is configured to determine if a given human operation from the workspace schedule 608 is completed based on the dynamic model, status of the automated tasks performed by the robot 102 from the adaptive robot control module 312, data from the plurality of sensors 124, or a combination thereof. In one form, the task completion parameter is based on a workpiece connectivity characteristic 610, a workspace audio-visual characteristic 612, a tool operation verification 614, a robot tactile verification 616, or a combination thereof.

The workpiece connectivity characteristic 610 determines if the human operation is complete based on an electrical connection, a mechanical connection, or a combination thereof between two or more components being connected during the human operation. For example, the human operation repository 604 may include information identifying two or more components to be assembled by the human operator, the type of connection(s) joining the components, and the location of the connection(s). If the human operation includes an electrical connection, the task completion module 606 determines if the connection formed by the human operator is electrically conductive by, for example, testing the operation of the electrically coupled components and/or using a voltage and/or a current sensor, to measure voltage and/or current through a circuit formed by the electrical connection. Based on the type of mechanical connection, the task completion module 606 may verify a mechanical connection by: determining if the appropriate number of fasteners were installed and if sufficient torque is applied to the fasteners; detecting an audible click when a first component is attached to a second component; conducting a visual inspection of the joint(s) formed by the components to assess if a gap is present and if so, if the gap is within a set tolerance; and/or performing a shake test in which the robot shakes the joint(s) formed by the components. While specific example are provided for verifying an electrical and mechanical connections, it should be readily understood that other tests may be used and the present disclosure should not be restricted to the examples provided herein.

The workspace audio-visual characteristic 612 determines if the human operation is complete based on a visual inspection, an acoustic evaluation, or a combination thereof of the workspace. Specifically, the sensors 124 include a camera operable to capture one or more images of the workspace 100 and an acoustic sensor (e.g., a microphone) operable to detect acoustic waves within the workspace 100.

For the visual inspection, the task completion module 606 is configured to compare a current state of the workspace 100 based on images from the camera with a predefined post operation state to determine if the two are substantially the same. The predefined post operation state provides a state of the workspace after the human operation is performed. The predefined post operation state of the workspace 100 includes, but is not limited, to a physical appearance of the workpiece after the human operation is performed, removal of an assembly component from a designated area, and/or transfer of an assembly component provided within the workspace. In one form, for the visual inspection, the task completion module 606 compares images of the workpiece with a predefined post operation state of the workpiece, such as a 3D-computer model.

For the acoustic evaluation, the task completion module analyzes a workspace audio signal that is indicative of the detected acoustic waves with a nominal audio signal profile. The nominal audio signal profile is indicative of an audio signal generated during the human operation under nominal condition (i.e., intended environmental conditions for the human operation). If the workspace audio signal is within a predefined range of the nominal audio signal profile, then the task completion module 606 determines that the human operation is complete.

The tool operation verification 614 determines whether a machine operation performed by the human operator 104 with the power tool 118 satisfies predefined tool criteria. That is, the human operation may include operating the power tool 118 to perform a machine operation. The task completion module 606 receives data indicative of the machine operation via the power tool 118. The data may include, but is not limited to a torque of the power tool 118, an electric power provided to the power tool 118, a contact state of a chuck of the power tool 118, and/or a contact state of a handle of the power tool 118.

In one form, the task completion module 606 may use data from the sensors 124 to determine whether the power tool 118 is operated in accordance with the machine operation. For example, the sensors 124 may include an infrared camera operable to acquire a thermal image of the workspace 100. For the tool operation verification, one of the predefined tool criteria is based on a nominal thermal profile of a selected portion of the workspace 100 at which the power tool 118 such as a blowtorch, is being operated during the human operation. The thermal profile can be used to determine if the blowtorch was operated, a temperature of the flame generated, and even a duration that the flame was active. This information can be compared to respective setpoints to determine if the human operation is complete.

The robot tactile verification 616 is performed by a robot as an automated task. More particularly, the robot is configured to perform a tactile evaluation of the processed workpiece using a tactile sensor such as a pressure sensor disposed at an end-effector. The task completion module 606 is configured to compare data from the tactile sensor to a post workpiece tactile threshold to verify whether the human operation is complete.

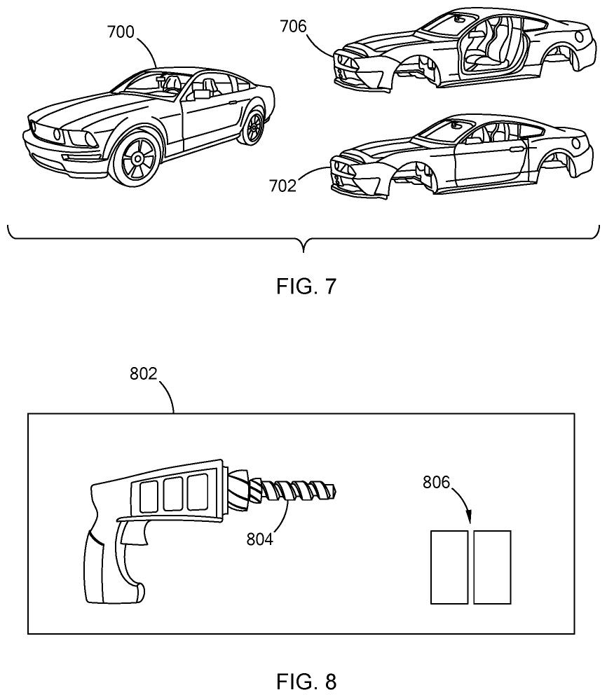

The task completion module may use one or more task completion parameters for verifying completion of the human operation. For example, referring to FIGS. 7 and 8, a human operation includes attaching a door to a vehicle using a power tool and multiple fasteners. For this operation, the human operation repository 604 provides the task completion parameters as the workspace audio-visual characteristic 610 and the tool operation verification 614, and includes supporting data/criteria such as the post operation state and predefined tool criteria.

For the workspace audio-visual characteristics 612, a visual inspection is performed of the vehicle and of the workspace to detect removal of an assembly component from a designated area. FIG. 7A, illustrates an image 700 of a vehicle (i.e., workpiece) taken by the sensors 124 and a predefined post operation state 702 of the vehicle. The task completion module 606 compares the two images to determine if the door is attached to the vehicle. The task completion module 606 may also receive a predefined operation state 706 of the vehicle before the human operation is to be performed. FIG. 8 illustrates a visual inspection of a table 802 that has a power tool 804 and an area 806 that held the fasteners for attaching the door to the vehicle. The task completion module 606 inspects the table 802 to determine whether the fasteners are still there. For the tool operation verification 614, the task completion module 606 acquires data from the power tool 804 to determine the machine operation of the power tool 804, and compares them with the predefined tool criteria. With the visual inspection and the tool operation verification, the task completion module 606 verifies whether the human operation is complete and the adaptive robot control module 312 operates the robot to perform a subsequent task.

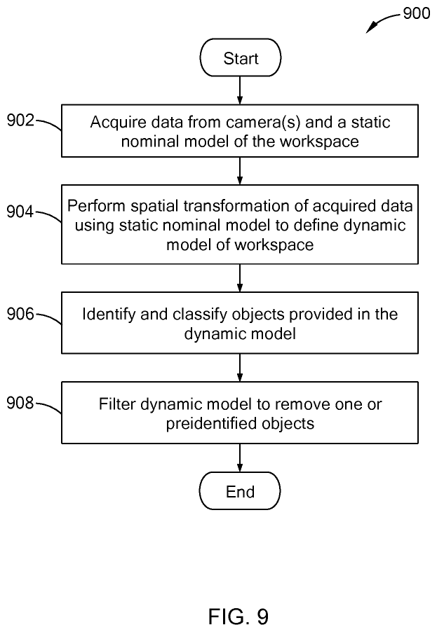

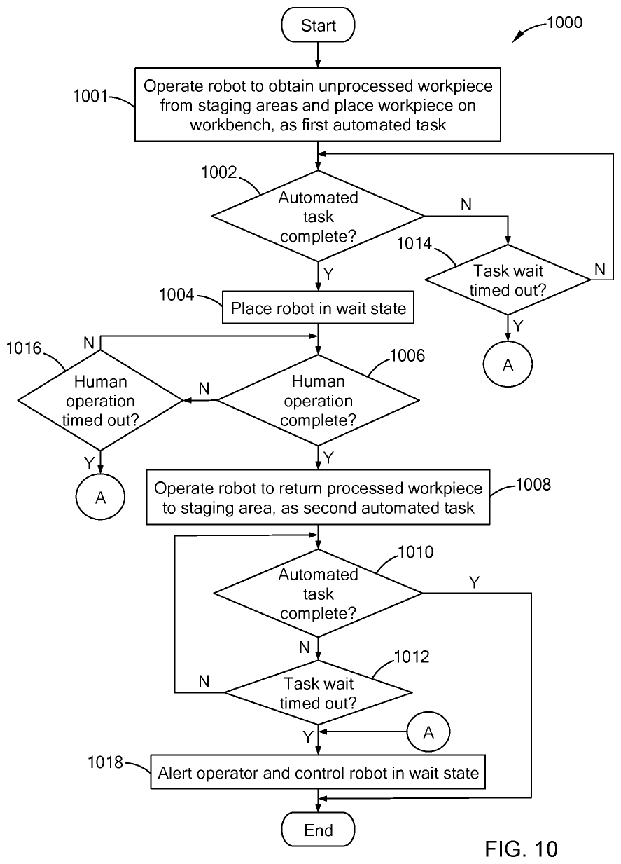

Referring to FIG. 9, an example dynamic workspace modeling routine 900 is provided and performed by the workspace controller. At 902, the controller acquires data from the sensors, which includes one or more cameras, and the static nominal model of the workspace. At 904, the workspace controller performs a spatial transformation based on the static nominal model to define the dynamic model. At 906, the workspace controller identifies and classifies objects provided in the dynamic model as described above, and filters selected objects from the dynamic model at 908. The workspace controller

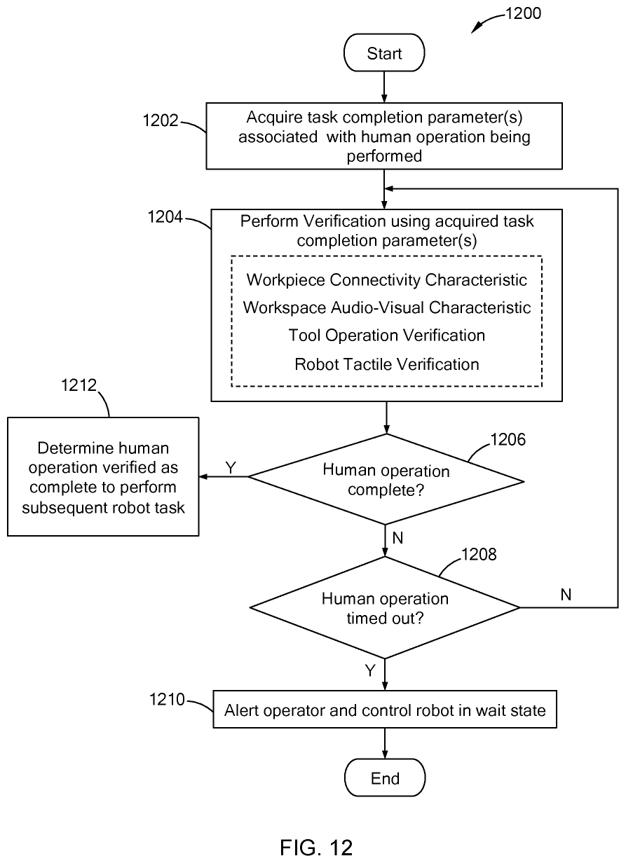

Referring to FIG. 10, an example robot operation routine 1000 is provided and performed by the workspace controller. For this routine, the robot is operated to perform two specific automated task and collaborate with a human operator. The automated tasks are for explanation purposes only, and it should be readily understood that other tasks may be performed. At 1001, the controller operates the robot to perform a first automated task of obtaining unprocessed workpiece from staging areas and place workpiece on a workbench. At 1002, the controller determines if the automated task is complete. If so, the controller, at 1004 places the robot in a wait state in which the robot is not moving, At 1006, the controller determines if the human operation is complete. For example, the controller performs a task completion routine of FIG. 12 to determine whether the human operation is complete.

If the human operation is complete, the controller, at 1008, operates the robot to perform a second automated task of returning the processed workpiece to the staging area. At 1010, the controller determines if the second automated task is complete, if so, the routine ends.

If the first automated task and/or the second automated are not completed, the controller determines if the task wait time has expired at 1012 and 1014 respectively. Similarly, if the human operation is not complete, the controller determines if the human operation has been timed out, at 1016. That is, the robot and human operator are given a predetermined time period, which may be different based on the task/operation, to perform the task/operation before being timed out. If the predetermined time period has lapsed, the controller issues a notification using the HMI to alert an operator and operates the robot in the wait state, at 1018.

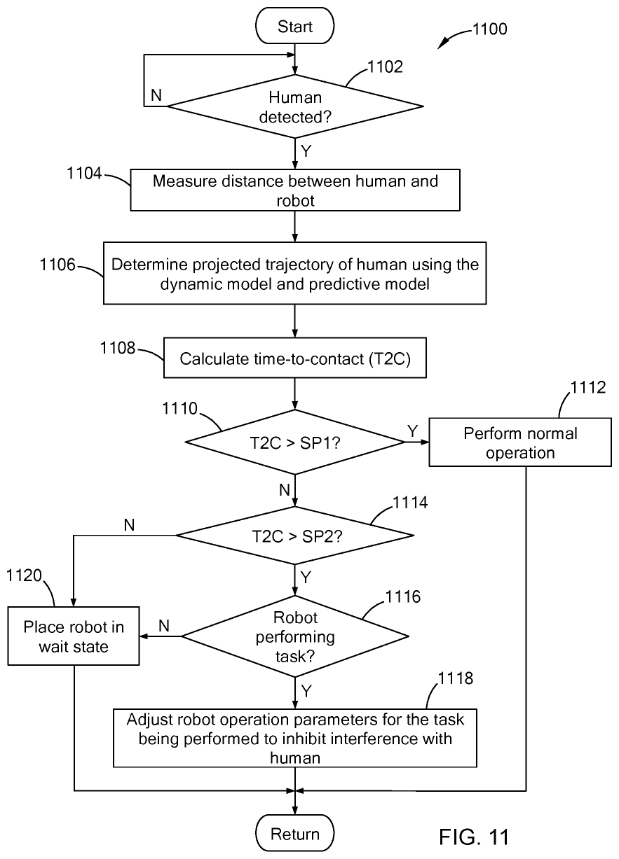

Referring to FIG. 11, an example adaptive robot control routine 1100 is provided and is executed by the workspace controller. The adaptive robot control routine 110 is performed concurrently with the robot operation routine 1000 to perform an adaptive control of the robot. At 1102, the controller determines if a human is detected based on the dynamic model. If so, the controller measures a distance between the human and the robot, at 1104 and determines a projected trajectory of the human using the dynamic model and predictive model, at 1106. At 1108, the controller calculates a time to contact (T2C), and determines if the T2C is greater than a first setpoint (SP1), at 1110. If so, the controller operates the robot under normal parameters, at 1112. If not, the controller determines if the T2C is greater than the second setpoint (SP2), 1114. If so, the controller determines if the robot is performing a task at 1116. If the robot is performing a task, the controller, at 1118, adjusts the robot operation parameters for the task being performed to inhibit interference with the human. The amount of adjustment needed may be based on predefined algorithms specific to the task being performed by the robot. If the T2C is less than the SP2 or the robot is not performing a task, the controller places the robot in a wait state at 1120.

Referring to FIG. 12, an example task completion routine 1200 is provided and performed by the controller to determine if the human operation is complete. At 1202, the controller acquires the task completion parameter(s) associated with the human operation being performed, and at 1204 performs the verification using the acquired task completion parameter(s). The task completion parameter is based on a workpiece connectivity characteristic, a workspace audio-visual characteristic, a tool operation verification, a robot tactile verification, or a combination thereof. At 1206, the controller determines if the human operation is complete. If no, the controller determines if the human operation has been timed out, at 1208. That is, the human operator is given a predetermined time period to perform the human operation before being timed out. If the predetermined time period has lapsed, the controller issues a notification using the HMI to alert an operator and operates the robot in the wait state, at 1210. If the human operation has not timed out, the controller performs the verification again at 1204. If the human operation is complete, the controller determines human operation is verified as complete to perform subsequent robot task, at 1212.

It should be readily understood that the routines 900, 1000, 1100, and 1200 are just one example implementation of the workspace controller and other control routines may be implemented.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice; material, manufacturing, and assembly tolerances; and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term “module” and/or “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

What is claimed is:

1. A system for a human-robot collaborative operation, the system comprising:
a plurality of sensors disposed throughout a workspace, wherein the plurality of sensors includes at least one sensor that acquires data related to a human operation to be performed by a human on a workpiece;
a robot operable to perform at least one automated task within the workspace; and
a workspace control system including:
a memory storing an object classification library that associates a plurality of predefined objects with one or more classifications; and
a workspace controller configured to operate as:
a dynamic workspace module configured to generate a dynamic model of the workspace based on a static nominal model of the workspace and data from the plurality of sensors, wherein the dynamic workspace module is configured to classify one or more objects provided within the workspace based on the dynamic model and the object classification library, and
a task management module configured to verify completion of the human operation based on a task completion parameter associated with the human operation, wherein the task management module is configured to determine whether the task completion parameter is satisfied based on at least one of the dynamic model, the data from the plurality of sensors, and the at least one automated task performed by the robot.

2. The system according to claim 1, wherein the task completion parameter is based on at least one of:
a workpiece connectivity characteristic, wherein the human operation includes connecting at least two components, and the task management module is configured to verify that the human operation is complete based on an electrical connection, a mechanical connection, or a combination thereof between the at least two components,
a workspace audio-visual characteristic, wherein the task management module is configured to verify that the human operation is complete based on a visual inspection, an acoustic evaluation, or a combination thereof of the workspace,
a tool operation verification of a power tool used by the human for performing the human operation, wherein the human operation includes a machine operation to be executed with the power tool, and the task management module is configured to determine whether the machine operation of the power tool satisfies a predefined tool criteria for the human operation, and
a robot tactile verification, wherein, as one of the at least one automated task, the robot is configured to perform a tactile evaluation of the workpiece using a tactile sensor, and the task management module is configured to compare data from the tactile sensor to a post workpiece tactile threshold to verify whether the human operation is complete.

3. The system according to claim 2, wherein:
the plurality of sensors includes a camera operable to capture one or more images of the workspace, an acoustic sensor operable to detect acoustic waves within the workspace, or a combination thereof, and
for the workspace audio-visual characteristic, the task management module is configured to perform at least one of:
compare a current state of the workspace having the workpiece with a work state to verify whether the human operation is complete, wherein the predefined post operation state provides a state of the workspace after the human operation is performed, and
analyze a workspace audio signal indicative of the detected acoustic waves with a nominal audio signal profile indicative of an audio signal generated during the human operation.

4. The system according to claim 3, wherein the predefined post operation state of the workspace includes at least one of: a physical appearance of the workpiece after the human operation is performed, removal of an assembly component from a designated area, and transfer of an assembly component provided within the workspace.

5. The system according to claim 2, wherein the at least one image sensor is an infrared camera operable to acquire a thermal image of the workspace, and for the tool operation verification, the predefined tool criteria is based on a nominal thermal profile of a selected portion of the workspace at which the power tool is being operated during the human operation.

6. The system according to claim 2, wherein the task management module is communicably coupled to the power tool to acquire data indicative of the machine operation performed by the power tool, wherein the data indicative of the machine operation includes at least one of a torque of the power tool, an electric power provided to the power tool, a contact state of a chuck of the power tool, and a contact state of a handle of the power tool.

7. The system according to claim 1, wherein the workspace controller is further configured to operate as:
an adaptive robot control module configured to operate the robot based on a comparison of the dynamic model and the static nominal model of the workspace, wherein the adaptive robot control module is configured to determine a probable trajectory of a dynamic object provided in the dynamic model based on a prediction model, wherein the prediction model determines probable trajectories of a dynamic object within the workspace and adjust at least one robot parameter based on the probable trajectory of the dynamic object and a future position of the robot.

8. The system according to claim 7, wherein the adaptive robot control module is configured to control subsequent movement of the robot after the task management module verifies completion of the human operation.

9. The system according to claim 1, wherein the object classification library associates the plurality of predefined objects with one of the following classifications: a robot, a human, a moveable object, or a fixed object.

10. The system according to claim 1, wherein the robot is uncaged.

11. The system according to claim 1 further comprising a plurality of the robots, wherein a first robot is operable to move the workpiece as a first automated task and a second robot is operable to inspect the workpiece as a second automated task, and the task management module is configured to determine whether the human operation is complete based on the second automated task.

12. A method comprising:
having a robot perform at least one automated task within a workspace;
generating a dynamic model of a workspace based on a static nominal model of the workspace and data from a plurality of sensors disposed throughout the workspace, wherein the plurality of sensors includes at least one sensor that acquires data related to a human operation to be performed by a human on a workpiece;
controlling operation of the robot based on the dynamic model and the human operation; and
verifying completion of the human operation based on a task completion parameter associated with the human operation and based on the dynamic model, the data from the plurality of sensors, the at least one automated task performed by the robot, or a combination thereof.

13. The method according to claim 12, wherein the task completion parameter is based on at least one of: a workpiece connectivity characteristic, a workspace audio-visual characteristic, a tool operation verification of a power tool used by the human for performing the human operation, and a robot tactile verification, wherein the method further comprises:
for the workpiece connectivity characteristic of the workpiece, determining whether at least two components to be connected during the human operation form an electrical connection, a mechanical connection, or a combination thereof between the at least two components,
for the visual characteristic of the workspace, comparing a current state of the workspace having the workpiece with a predefined post operation state to verify whether the human operation is complete, wherein the predefined post operation state provides a state of the workspace after the human operation is performed,
for the workspace audio-visual characteristic, verifying that the human operation is complete based on a visual inspection, an acoustic evaluation, or a combination thereof of the workspace,
for the tool operation verification of a power tool used by the human for performing the human operation, determining whether a machine operation of the power tool that is included as part of the human operation satisfies a predefined tool criteria, and
for the robot tactile verification in which one of the at least one automated task of the robot includes a tactile evaluation of the workpiece using a tactile sensor, comparing data from the tactile sensor to a post workpiece tactile threshold to verify whether the human operation is complete.

14. The method according to claim 13, wherein for the workspace audio-visual characteristic, the method further includes:
(1) comparing a current state of the workspace having the workpiece with a work state to verify whether the human operation is complete, wherein the predefined post operation state provides a state of the workspace after the human operation is performed,
(2) measuring audible signal within the workspace during the human operation, and comparing a workspace audio signal profile indicative of the measured audible signal with a nominal audio signal profile indicative of an audio signal generated during the human operation under nominal operating conditions, or
(3) combination of (1) and (2).

15. The method according to claim 14, wherein the predefined post operation state of the workspace includes a physical appearance of the workpiece after the human operation is performed.

16. The method according to claim 13, wherein the at least one image sensor is an infrared camera operable to acquire a thermal image of the workspace, and for the tool operation verification, the predefined tool criteria is based on a thermal profile of a selected portion of the workspace at which the power tool is being operated during the human operation.

17. The method according to claim 13 further comprising acquiring data indicative of the machine operation performed by the power tool, wherein the data indicative of the machine operation includes at least one of a torque of the power tool, an electric power provided to the power tool, a contact state of a chuck of the power tool, and a contact state of a handle of the power tool.

18. The method according to claim 13 further comprising:
determining a probable trajectory of a dynamic object provided in the dynamic model based on a prediction model, wherein the prediction model determines probable trajectories of the dynamic object within the workspace;
adjusting at least one robot parameter based on the probable trajectory of the dynamic object and a future position of the robot; and
operating the robot to perform a subsequent task after the human operation is verified as being completed.

19. A method comprising:
having a robot perform at least one automated task within a workspace;
generating a dynamic model of a workspace based on a static nominal model of the workspace and data from a plurality of sensors disposed throughout the workspace, wherein the plurality of sensors includes at least one sensor that acquires data related to a human operation to be performed by a human on a workpiece;
identifying the human within the dynamic model;
determining a probable trajectory of the human provided in the dynamic model based on a prediction model, wherein the prediction model determines probable trajectories of a dynamic object within the workspace;
controlling operation of the robot based on the probable trajectory of the human and a future position of the robot; and
verifying completion of the human operation based on a task completion parameter associated with the human operation and on based on at least one of the dynamic model, the data from the plurality of sensors, and the at least one automated task performed by the robot.

20. The method according to claim 19, wherein the task completion parameter is based on at least one of: a connectivity characteristic of the workpiece, a visual characteristic of the workspace, a tool operation verification of a power tool used by the human for performing the human operation, and a robot tactile verification, wherein the method further comprises:
for the connectivity characteristic of the workpiece, determining whether at least two components to be connected during the human operation form an electrical connection, a mechanical connection, or a combination thereof between the at least two components,
for the visual characteristic of the workspace, comparing a current state of the workspace having the workpiece with a predefined post operation state to verify whether the human operation is complete, wherein the predefined post operation state provides a state of the workspace after the human operation is performed,
for the tool operation verification of a power tool used by the human for performing the human operation, determining whether a machine operation of the power tool that is included as part of the human operation satisfies a predefined tool criteria, and
for the robot tactile verification in which one of the at least one automated task of the robot includes a tactile evaluation of the workpiece using a tactile sensor, comparing data from the tactile sensor to a post workpiece tactile threshold to verify whether the human operation is complete.
